(19) United States
(12) Patent Application Publication
(10) Pub. No.: US 2025/0079061 A1
(43) Pub. Date: Mar. 6, 2025

(54) TRANSFORMER PACKAGES WITH CONTROLLED MAGNETOSTRICTION

(71) Applicant: Allegro MicroSystems, LLC, Manchester, NH (US)

(72) Inventors: Paul A. David, Bow, NH (US); Maurizio Salato, Bedford, MA (US); Andrew Thompson, Cheshire (GB); Joseph Duigan, Peymeinade (FR); Andrew Bernard Keogh, Cork (IE); William P. Taylor, Amherst, NH (US)

(73) Assignee: Allegro MicroSystems, LLC, Manchester, NH (US)

(21) Appl. No.: 18/456,666

(22) Filed: Aug. 28, 2023

(51) Int. Cl. H01F 27/24; H01F 1/147; H01F 27/28; H01F 41/00

(52) U.S. Cl. CPC H01F 27/24; H01F 1/147; H01F 27/2804; H01F 27/2823; H01F 41/005

(57) ABSTRACT

Aspects of the present disclosure include galvanically-isolated (voltage-isolated) transformer-based integrated circuit (IC) packages providing cavities or spaces for an included magnetic core to underdo size changes due to magnetostriction without being constrained or substantially constrained, thus, providing for improved magnetic performance. The circuits, ICs and IC packages and modules may include various types of circuits. In some examples, IC packages or modules may include a galvanically-isolated gate driver or other high voltage circuit.

### BACKGROUND

Solid state switches typically include a transistor structure. The controlling electrode of the switch, usually referred to as its gate (or base), is typically controlled (driven) by a switch drive circuit, sometimes also referred to as gate drive circuit. Such solid state switches are typically voltage-controlled, turning on when the gate voltage exceeds a manufacturer-specific threshold voltage by a margin, and turning off when the gate voltage remains below the threshold voltage by a margin.

Switch drive circuits typically receive their control instructions from a controller such as a pulse-width-modulated (PWM) controller via one or more switch driver inputs. Switch drive circuits deliver their drive signals directly (or indirectly via networks of active and passive components) to the respective terminals of the switch (gate and source).

Some electronic systems, including ones with solid state switches, have employed galvanic isolation to prevent undesirable DC currents flowing from one side of an isolation barrier to the other. Galvanic isolation can be used to separate circuits in order to protect users from coming into direct contact with hazardous voltages, which can be present for high-power solid state switches.

Various transmission techniques are available for signals to be sent across galvanic isolation barriers including optical, capacitive, and magnetic coupling techniques. Magnetic coupling typically relies on use of a transformer to magnetically couple circuits on the different sides of the transformer, typically referred to as the primary and secondary sides, while also providing galvanic separation of the circuits. Transformer-based magnetic coupling has presented problems for integrated circuit packages arising from the presence of the transformer structure including transformer core.

### SUMMARY

An aspect of the present disclosure is directed to and includes transformer-based galvanically-isolated (voltage-isolated) integrated circuit (IC) packages providing cavities or spaces for an included magnetic core or portion of the core to undergo size changes due to magnetostriction during operation without being constrained or substantially constrained, thus, providing for improved magnetic performance.

One aspect includes a method of making a transformer package with controlled magnetostriction. The method can include providing a substrate having first and second opposed surfaces. An aperture can be formed in the substrate. The aperture can be blocked with a ferromagnetic core including soft ferromagnetic material and having first and second core portions, where the second core portion is unconstrained by the substrate. The first core portion and an exposed portion of the first surface of the substrate can be covered with a protective material. A body can be formed about the substrate and ferromagnetic core, where the body may include a mold material.

Implementations may include one or more of the following features. The aperture may include first and second apertures in the first surface of the substrate connected by a cavity in the second surface of the substrate. The method may include bonding the second core portion to the first core portion. The aperture may include a cavity with a closed shape and surrounding a region of the first surface of the substrate; the first core portion can have a shape matching the closed shape of the cavity. Blocking the aperture with the first core portion may include covering the aperture with the first core portion, where the first core portion has an area greater than that of the aperture. The method may include providing the first core portion with a shaped surface configured for reception by a receiving surface of the substrate. The shaped surface may include one or more surfaces oblique to the substrate. The shaped surface may include one or more stepped surfaces.

The substrate may include a printed circuit board (PCB). The substrate may include a lead frame. The substrate may include a ceramic substrate. The substrate may include an alumina substrate. The substrate may include a glass substrate. The aperture can include an elliptical shape. The aperture can include a circular shape. The aperture can include a rectangular shape. The aperture can include a square-like shape.

The method may include applying an adhesive between the first surface of the substrate and the first core portion for facilitating sealing of the aperture. The adhesive may include epoxy loaded with soft ferromagnetic material. The method may include covering the second core portion and the second surface of the substrate with a protective material. The method may include mounting one or more circuit components to the first surface of the substrate. The one or more circuit components may include one or more integrated circuit die. The substrate can include a plurality of first coil portions configured to extend about the ferromagnetic core. The method may include connecting a plurality of second coil portions to the plurality of first coil portions, forming a plurality of coil windings about the ferromagnetic core. The plurality of coil windings may include primary and secondary transformer coils configured for magnetic coupling. The substrate may include first and second transformer coils disposed about the aperture and configured for magnetic coupling. The ferromagnetic core may include ferrite in some examples.

Another aspect can include a transformer package having controlled magnetostriction. The transformer package can include a substrate with first and second surfaces, where an aperture is disposed in the first surface. The transformer package can include a ferromagnetic core including soft ferromagnetic material and having first and second core portions, where the first core portion is configured to block the aperture, and where the second core portion is unconstrained by the substrate. The package can include a body disposed about the substrate and ferromagnetic core, where the body may include a mold compound.

Implementations may include one or more of the following features. The aperture of the transformer package may include first and second apertures in the first surface of the substrate connected by a cavity in the second surface of the substrate. The second core portion can be affixed to the first core portion. The transformer package may include an adhesive disposed between the first core portion and the second core portion. The adhesive may include epoxy loaded with soft ferromagnetic material. The second core portion can be integral with the first core portion. The aperture may include a cavity with a closed shape and surrounding a region of the first surface of the substrate, where the first core portion can have a shape matching the closed shape of the cavity. The first core portion can have an area greater than that of the aperture. The first core portion can include a shaped surface configured for reception by a receiving surface of the substrate. The shaped surface may include one or more surfaces oblique to the substrate. The shaped surface may include one or more stepped surfaces. The substrate may include a printed circuit board (PCB). The substrate may include a lead frame. The substrate may include a ceramic substrate. The substrate may include an alumina substrate. The substrate may include a glass substrate. The aperture includes an elliptical shape. The aperture includes a circular shape. The aperture can include a rectangular shape. The aperture can include a square-like shape.

The transformer package may include an adhesive disposed between the first surface of the substrate and the first core portion for facilitating sealing of the aperture. The transformer package may include a protective material covering the first core portion and an exposed portion of the first surface of the substrate. The transformer package may include a protective material covering the second core portion and the second surface of the substrate. The transformer package may include one or more circuit components disposed on the first surface of the substrate. The one or more circuit components may include one or more integrated circuit die. The plurality of second coil portions extend about the ferromagnetic core, and where the plurality of first coil portions and plurality of second coil portions, as connected, form a plurality of continuous coil loops about the ferromagnetic core. The plurality of continuous coil loops may include primary and secondary transformer coils configured for magnetic coupling. The plurality of second coil portions may include wire bonds. The substrate may include first and second transformer coils disposed about the aperture and configured for magnetic coupling. The ferromagnetic core may include ferrite in some examples.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed examples and embodiments of the present disclose may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principals of the concepts described herein. Furthermore, examples and embodiments are illustrated by way of example and not limitation in the figures, in which:

FIG. 1 is a section side view of an example cap-type transformer-based IC package structure during successive steps of fabrication, in accordance with an embodiment of the present disclosure;

FIG. 2 is a section side view of another example of a cap-type transformer-based IC package structure during successive steps of fabrication, in accordance with an embodiment of the present disclosure;

FIGS. 3A-3B show top views of an example cap-type transformer-based IC package structure in an unassembled state and an assembled state, respectively, in accordance with an embodiment of the present disclosure.

FIG. 4 is a section side view of an example wedge-type transformer-based IC package structure during successive steps of fabrication, in accordance with an embodiment of the present disclosure;

FIG. 5 is a section side view of another example wedge-type transformer-based IC package structure during successive steps of fabrication, in accordance with an embodiment of the present disclosure;

FIG. 6 is a section side view of a further example wedge-type transformer-based IC package structure during successive steps of fabrication, in accordance with an embodiment of the present disclosure;

FIGS. 7A-7B show top views of an example wedge-type transformer-based IC package structure in an unassembled state and an assembled state, respectively, in accordance with a further embodiment of the present disclosure; and

FIG. 8 is a diagram showing steps in an example method of fabricating a transformer-based IC package with preformed pockets for accommodating size changes of the core due to magnetostriction, in accordance with the present disclosure.

### DETAILED DESCRIPTION

The features and advantages described herein are not all-inclusive; additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Aspects of the present disclosure are directed to and include systems, structures, circuits, and methods providing transformer-based IC packages and related structures having pockets or cavities for accommodating expansion of the included transformer core due to magnetostriction during operation of the transformer.

Examples and embodiments can include integrated circuit (IC) packages or modules with a voltage-isolation transformer providing galvanic isolation (voltage isolation) between a primary side and a secondary side. Examples and embodiments can include data transmitter and receiver for data communication across a transformer-based isolation barrier. The IC packages and modules may include various types of circuits; in some examples, IC packages or modules may include a galvanically isolated gate driver or other high voltage circuit, etc. First and second semiconductor IC die can be included in the package to provide integrated circuits (ICs), e.g., including, but not limited to, controllers and/or high-voltage circuits such as gate drivers configured to drive an external gate on a MOSFET, SiC FET, GaN FET, IGBT, high electron mobility transistor (HEMT), e.g., GaN HEMT, or another load. In some embodiments, the transformers can have step-up, step-down, or power transformer configurations. In some embodiments, a secondary side of a transformer may be a high-voltage side of a step-up transformer configuration.

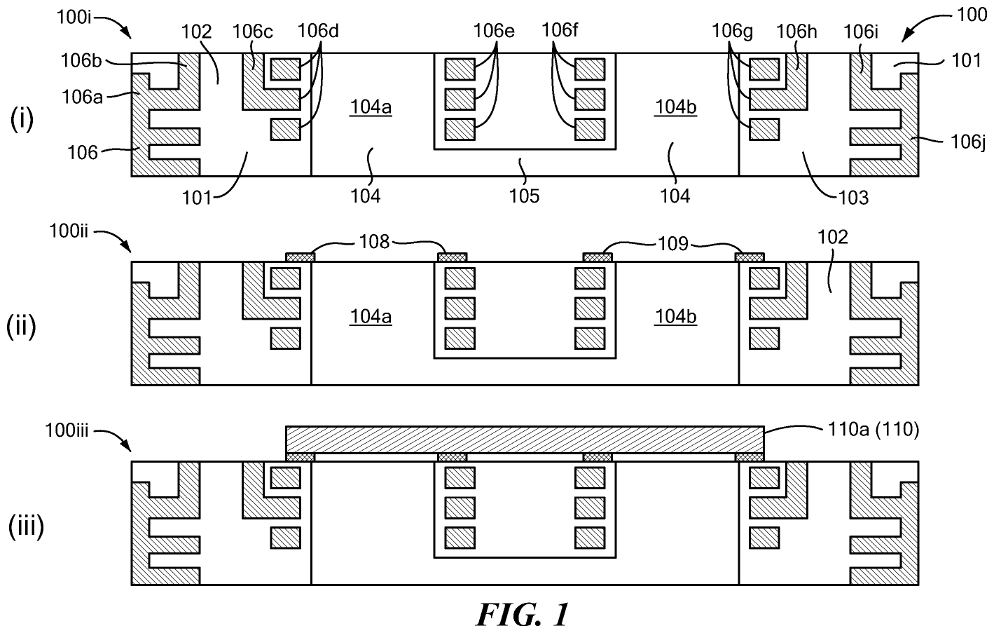

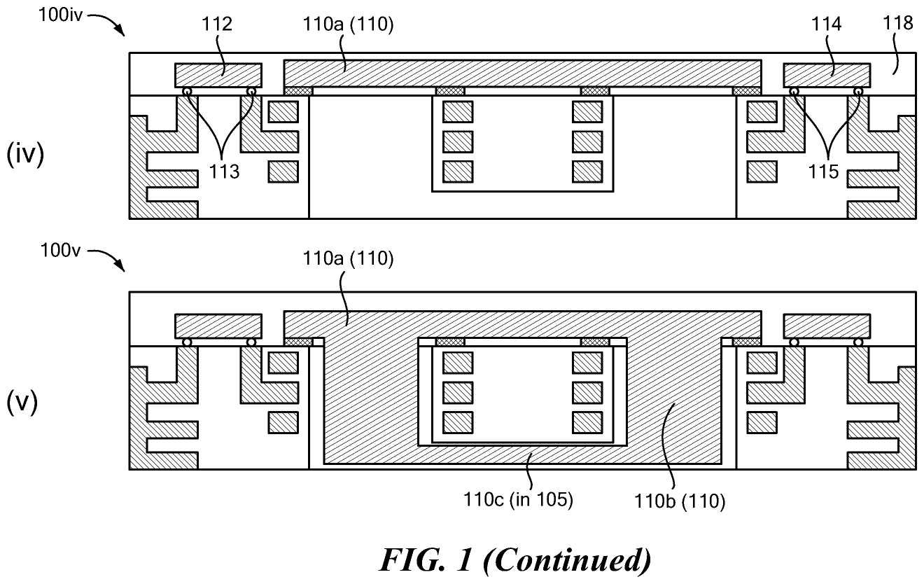

FIG. 1 is a section side view of an example cap-type transformer-based IC package structure 100 during successive steps (i)-(v) of fabrication, in accordance with an embodiment of the present disclosure. Transformer-based IC package structure 100 can provide voltage isolation between primary and secondary sides of the included transformer. Structure 100 includes structures 100i-100v at different steps (i)-(v) of fabrication. As explained below, IC package structure 100 provides/includes cavities or spaces for an included magnetic core 110, shown with parts/portions 110a-c, to undergo size changes due to magnetostriction during operation without being constrained or substantially constrained, thus, providing for improved magnetic performance of the transformer of IC package 100.

As shown for step (i), structure 100i can include a substrate 101 having opposed first and second sides (surfaces) 102, 103. Substrate 101 can include or be formed of a printed circuit board (PCB) in some embodiments. An aperture 104 can be formed in the substrate that is configured (adapted) to receive a magnetic transformer core, shown as core 110 for steps (iii)-(v). Aperture 104 can include first and second sections 104a-b that are each configured to receive a portion of the magnetic core 110 used for the transformer of structure 100, as described in further detail below. In some embodiments, aperture 104 can be formed, e.g., by machining of or molding for substrate 101. Aperture sections 104a-b can have any suitable geometry or geometries, e.g., circular, oval, square, rectangular, polygonal, etc.; in some embodiments, aperture sections 104a and 104b may be different. Cavity 105 can be connected to or part of aperture 104 and shaped to receive a portion of the transformer core 110, as described in further detail below.

Substrate 101 can include a plurality of conductive structures (traces) 106 that can be used for connections to external components (e.g., as shown by 106a and 106j), connections for internal components such as active components and/or passive components (e.g., as shown by 106b, 106c, 106h, and 106i), and/or for connection to or use as transformer coils or portions of transformer coils (e.g., as shown by 106d-e and 106f-g). For example, in some embodiments, traces shown by 106d-e can form complete loops of a primary coil used for a transformer of structure 100 and traces shown by 106f-g can form complete loops of a secondary coil used for the transformer of structure 100.

As shown for (optional) step (ii), structure 100ii can include adhesive 108, 109 applied to edges of aperture 104, e.g., on edges of aperture sections 104a and 104b, on substrate surface 102. Adhesive 108 is shown applied to surface 102 at a perimeter of aperture section 104a while adhesive 109 is shown applied to surface 102 at a perimeter of aperture section 104b. Adhesive 108, 109 may be applied to improve sealing between the transformer core 110 and substrate 101, in some embodiments.

As shown for step (iii), structure 100iii can include a first portion 110a (a.k.a., “cap”) of ferromagnetic core 110. First core portion 110a can be positioned on or adjacent to the first surface 102 of the substrate 101 and covering the aperture 104 (aperture sections 104a-b) on side 102, as shown. Passive and/or active components (e.g., IC die) may be added at this step or for other steps, e.g., step (iv).

As shown for step (iv), structure 100iv can include protective material 118 can be applied/provided (e.g., molded, potted, or dispensed) to protect components of the package. As shown by IC die 112, 114, active and/or passive components may be added at this step. Solder (e.g., solder balls 113, as shown) or other suitable (e.g., reflowable and/or conductive) material may be used for connections to/for active or passive components. The seal between the first substrate portion 110a and substrate 101 can prevent material (e.g., protective material and/or mold material) from entering aperture 104, in some embodiments.

As shown for step (v), structure 100v can include a second portion 110b of ferromagnetic core 110. Second core portion 110b can be disposed in or received by aperture sections 104a-b. The second core portion 110b may be glued or adhered/affixed to first portion 110b using different processes/materials. In some examples, epoxy loaded with soft ferromagnetic material can be used for bonding second core portion 110b to first core portion 110a. Suitable soft ferromagnetic materials that can be loaded (dispersed) in epoxy can include, but are not limited to, ferrite, iron, nickel, and nickel-iron alloys, and the like. A third (backing) portion 110c of core 110 (shown as part of or integral with second portion 110b) can be disposed in or received by cavity (pocket) 105 of aperture 104, as shown. In some embodiments, package structure 100v can be further processed, e.g., subject to a compression molding step (not shown), for forming an IC package.

Any suitable soft ferromagnetic material(s) may be used for magnetic core 110 (including core portions 110a-c). In some embodiments, a nickel or nickel-iron alloy, or other electrically conductive soft ferromagnetic material or alloy may be used for any or all of core portions 110a-c. In some embodiments, powdered iron may be used for magnetic core 110.

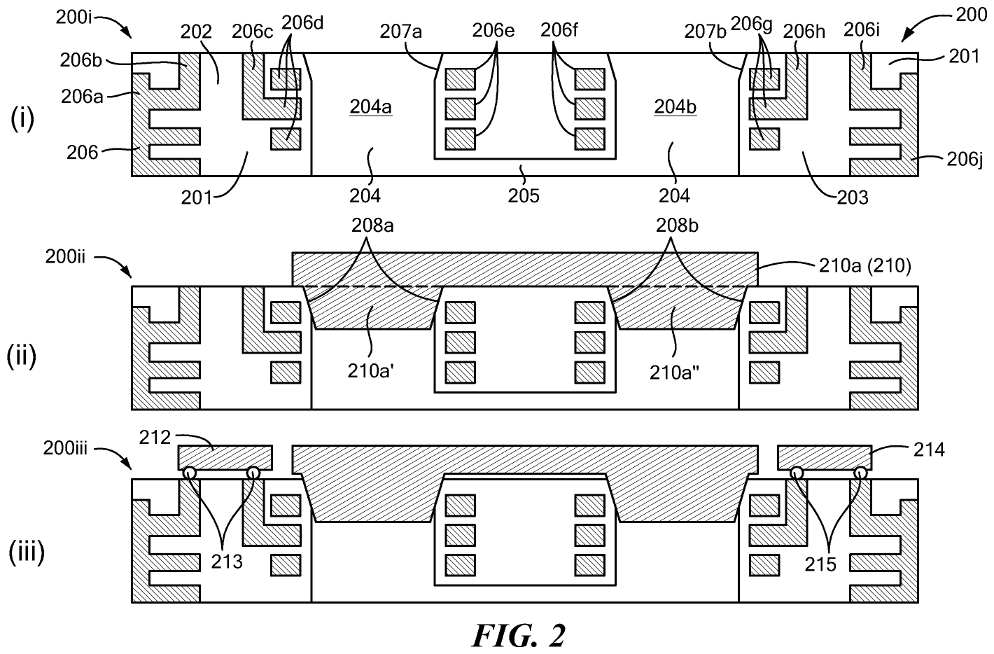

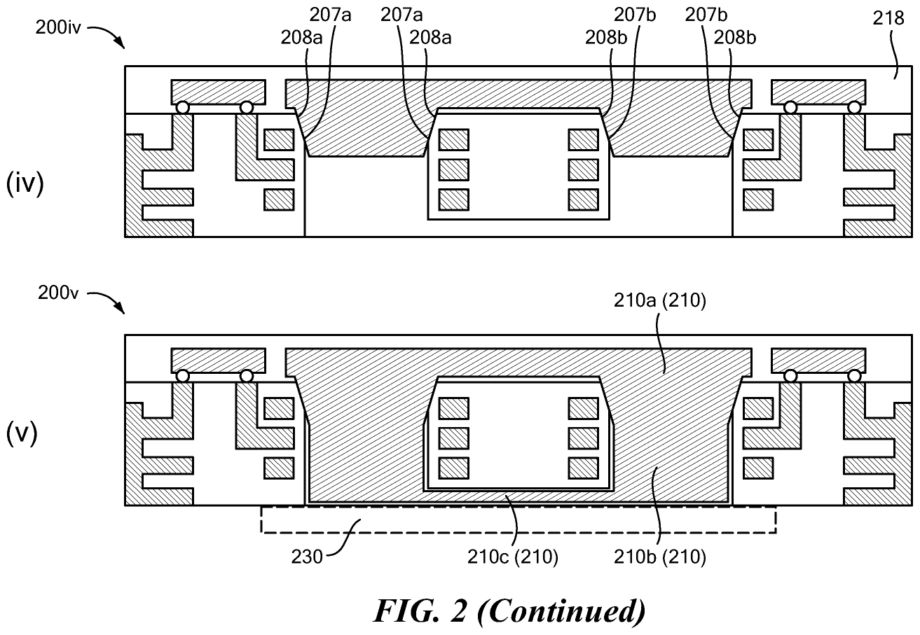

FIG. 2 is a section side view of another example cap-type transformer-based IC package structure 200 during successive steps (i)-(v) of fabrication, in accordance with an embodiment of the present disclosure. Transformer-based IC package structure 200 can provide voltage isolation between primary and secondary sides of the included transformer. Structure 200 includes structures 200i-200v at different steps (i)-(v) of fabrication. IC package structure 200 provides/includes cavities or spaces for an included magnetic core 210 (shown with parts/portions 210a-c) to undergo size changes due to magnetostriction during operation without being constrained or substantially constrained, thus, providing for improved magnetic performance during operation of the included transformer.

As shown for step (i), structure 200i can include a substrate 201 having opposed first and second sides (surfaces) 202, 203. Substrate 201 can include or be formed of a printed circuit board (PCB) in some embodiments. An aperture 204 can be formed in or for substrate 201 that is configured (adapted) to receive a magnetic transformer core, shown as core 210 for steps (iii)-(v). Aperture 204 can include first and second sections 204a-b that are each configured to receive a portion of the magnetic core 210 used for the transformer of structure 200, as described in further detail below. In some embodiments, aperture 204 can be formed by, e.g., machining of or molding for substrate 201. Aperture sections 204a-b can have any suitable geometry or geometries, e.g., circular, oval, square, rectangular, polygonal, etc. In some embodiments, aperture sections 204a and 204b may have different shapes/geometries. Cavity (pocket) 205 is also shown as part of aperture 205. Cavity 205 can be shaped to receive a portion of the transformer core, as described in further detail below. Structure 200i is generally similar to structure 100i of FIG. 1 but includes shaped surfaces, shown as angled surfaces 207a-b, for substrate 201. As explained below, such shaped surfaces (e.g., angled surfaces 207a-b) can be configured to receive respective surfaces formed in a portion of transformer core 210, e.g., first portion 210a (a.k.a., “cap”). Such a configuration can facilitate positioning of transformer core 210 relative to aperture 204 and/sealing of aperture 204.

Substrate 201 can include a plurality of conductive structures (traces) 206 that can be used for connections to external components (e.g., as shown by 206a and 206j), connections for internal components such as active components and/or passive components (e.g., as shown by 206b, 206c, 206h, and 206i), and/or for connection to or use as transformer coils or portions of transformer coils (e.g., as shown by 206d-e and 206f-g). For example, in some embodiments, traces shown by 206d-e can form loops of a primary coil used for a transformer of structure 200 and traces shown by 206f-g can form loops of a secondary coil used for the transformer of structure 200.

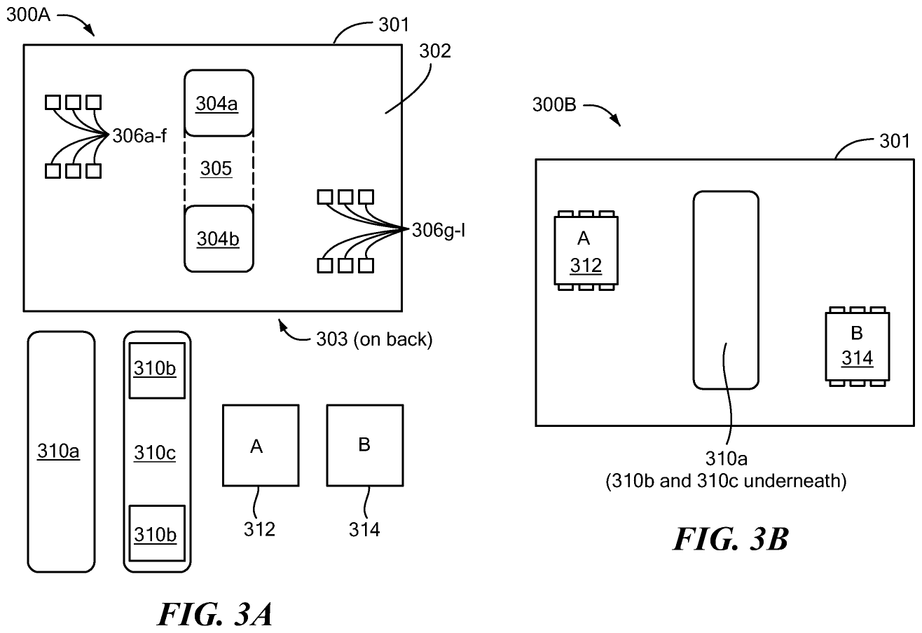

As shown for step (ii), structure 200ii can include first portion (cap) 210a of the ferromagnetic core 210. First portion 210a can be provided for (positioned adjacent) the first surface 202 of the substrate 201. First core portion 210a can cover the aperture 204 on side 202, as shown. First core portion 210a can include protruding features (protrusions) 210a′-210a″, having shaped surfaces, shown as angled surfaces 208a-b, configured to contact (mate with), respective receiving surfaces, shown as angled surfaces 207a-b, of substrate 201. In alternate embodiments, other configurations of shaped surfaces may be used, e.g., stepped surfaces (such as shown for FIG. 3).

As shown for step (iii), passive and/or active components may be added for structure 200iii. Structure 200iii is shown including IC die 212 and 214, which may be connected to respective sides, e.g., primary and secondary sides, of the transformer included within structure 200. Solder (e.g., solder balls 213, 215) or other suitable (e.g., reflowable and/or conductive) material may be used for connections to/for active or passive components.

As shown for step (iv), structure 200iv can include protective material 218, which can be applied (e.g., molded, potted, or dispensed) to protect components of the package structure 200. The seal(s) between first core portion (cap) 210a at angled surfaces 208a-b and respective surfaces 207a-b of substrate 201 can prevent material (e.g., protective material 218) from entering aperture 204.

As shown for step (v), a second portion 210b of the ferromagnetic core 210 can be applied to complete the transformer core 210 for structure 200v. The second core portion 210b may be glued or adhered/affixed to first core portion 210b using different processes/materials. A third (backing) portion 210c of core 210 (shown as part of or integral with second core portion 210b) can be disposed in or received by cavity 205 of aperture 204, as shown. In some embodiments, additional suitable material 230 (e.g., protective material) may be applied to surface 203 to seal aperture 204 and/or cavity 205.

In some embodiments, package structure 200v can be further processed, e.g., subject to a compression molding step (not shown), for forming an IC package. Any suitable soft ferromagnetic material(s) may be used for magnetic core 210 including core portions 210a-c. In some embodiments, a nickel or nickel iron alloy, or other electrically conductive soft ferromagnetic material or alloy may be used for any or all of core portions 210a-c.

FIGS. 3A-3B show top views of an example cap-type transformer-based IC package structure 300 in an unassembled state 300A and an assembled state 300B, respectively, in accordance with an embodiment of the present disclosure. Transformer-based IC package structure 300 can provide voltage isolation between primary and secondary sides of the included transformer and includes a cavity or cavities for a portion of the included transformer core to accommodate core size changes due to magnetostriction.

FIG. 3A shows structure 300A including a substrate (e.g., PCB) 301 and an aperture 304, including aperture sections 304a-b. Substrate 301 includes a first side 302 and a second side 303. Aperture 304 can include a cavity 305 (similar to cavity 105 of FIG. 1) in second side 303 of substrate 301. Cavity 305 may connect aperture sections 304a-b. Structure 300A includes a number of conductive pads/traces 306a-f and 306g-l configured for connection to IC die 312 and 314. Structure 300A can include additional conductive structure, e.g., traces disposed around aperture sections 304a-b, within substrate 301 that can be used for primary and secondary transformer coils (not shown). First transformer core portion 310a (“cap”) is shown adjacent to second core portion 310b and third core portion 310c. Second core portion 310b (with two parts indicated) is shown stacked on third core portion 310c.

FIG. 3B shows structure 300B as assembled from components in FIG. 3A. Die 312 and 314 are shown as connected to (positioned atop and in contact with) conductive pads/traces 306a-f and 306g-l. First core portion 310a is shown covering aperture 304 and aperture sections 304a-b. Second and third core portions 310b, 310c are blocked from view by first core portion 310a but are connected to each other and first core portion 310a, with second core portion 310b being received in aperture sections 304a-b. Third core portion 310c can be received by cavity 305 (formed in the side of substrate 301 facing away from the view shown) included in aperture 304. While not shown, in some embodiments additional active and/or passive components may be included for structure 300B. Structure 300B may be further processed, e.g., in one or more compression molding steps, to form a completed IC package. In operation, second core portion 310b and third core portion 310c are unconstrained during size changes of core 310 due to magnetostriction.

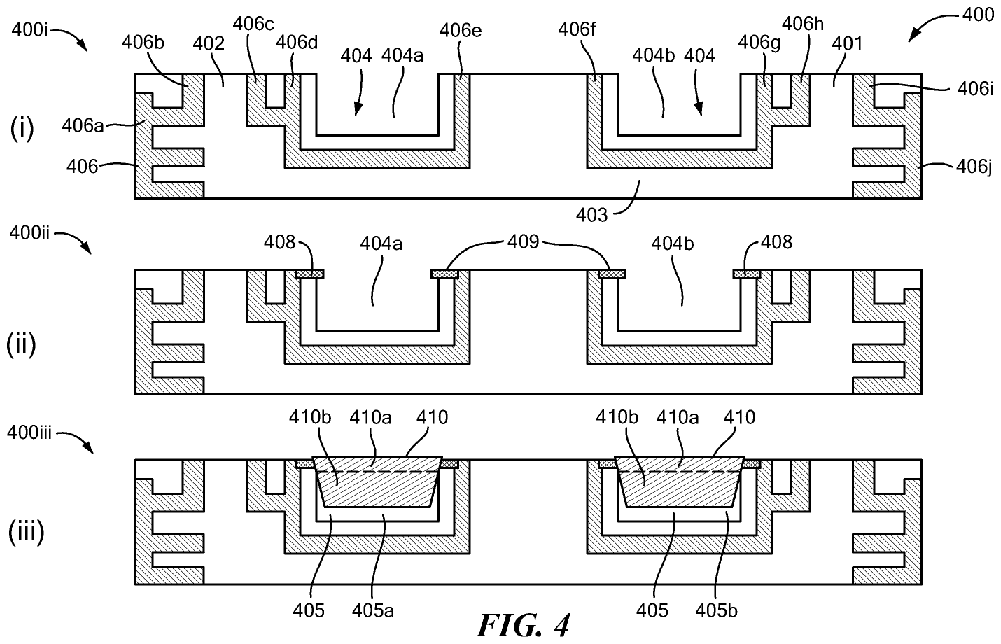

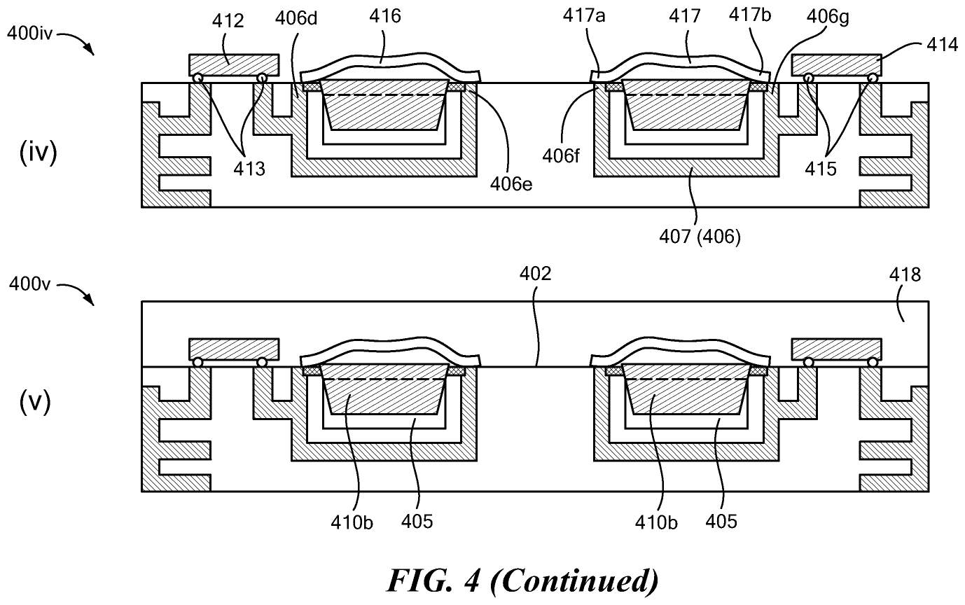

FIG. 4 is a section side view of an example wedge-type transformer-based IC package structure 400 during successive steps (i)-(v) of fabrication, in accordance with an embodiment of the present disclosure. Transformer-based IC package structure 400 can provide voltage isolation between primary and secondary sides of the included transformer. Structure 400 includes structures 400i-400v at different steps (i)-(v) of fabrication.

As shown for step (i), structure 400i can include a substrate 401 having opposed first and second sides (surfaces) 402, 403. Substrate 401 can be formed of or include a printed circuit board (PCB) in some embodiments. An aperture 404, shown with section areas 404a-b, can be formed in substrate 401 that is configured to receive (adapted to) a magnetic transformer core. Aperture 404 can be configured as a closed loop, e.g., trench or depression, in a surface (e.g., 402) of substrate 401. The magnetic core, shown as core 410 for steps (iii)-(v), can likewise be configured as a closed loop generally similar to that of aperture 404, such that a portion of core 410 can be placed (acting as a wedge that is wedged) into aperture 404, e.g., with an interference fit, as described below. In some embodiments, aperture 404 can be machined or molded. Aperture 404 can be shaped as a closed loop having various geometries, e.g., circular, oval, square, rectangular, polygonal, etc.

Substrate 401 can include a plurality of conductive structures (traces) 406 that can be used for connections to external components (e.g., shown as 406a and 406j), connections for internal components such as active components and/or passive components (e.g., shown as 406b, 406c, 406h, and 406i), and/or for connection to or use as transformer coils or portions of transformer coils (e.g., shown as 406de and 406f-g).

As shown for (optional) step (ii), structure 400ii can include adhesive 408, 409 applied to edges of aperture 404 (aperture sections 404a-b) on substrate surface 402. Adhesive 408 is shown applied to surface 402 at an outer perimeter of aperture 404 while adhesive 409 is shown applied to surface 402 at an inner perimeter of aperture 404. Adhesive 408, 409 may be applied to improve sealing between the transformer core 410 and substrate 401, in some embodiments.

As shown for step (iii), structure 400iii can include a ferromagnetic core 410 including a first portion 410a and a second portion 410b. First core portion 410a can be positioned relative to aperture 404 (wedged into) to occlude or block the aperture 404 at the first surface 402, forming a pocket or cavity 405, shown with sections 405a-b. Second core portion 410b is unconstrained by substrate 401 and may move or change size (in pocket 405) in response to magnetostriction during operation of the transformer of structure 400. The seal (e.g., including adhesive 408/409) between the first core 410a portion and substrate 401 can prevent material (e.g., molding compound or protective material, etc.) from entering aperture 404. For the example shown, second core portion 410b is integral with first core portion 410a. In other embodiments, the second portion 410b may be glued or adhered/affixed to first portion 410b using suitable processes/materials.

As shown for step (iv), structure 400iv can include protective material provided or applied (e.g., molded, potted, or dispensed) to protect components of the package. As shown by IC die 412, 414, active and/or passive components may be added at this step. Further conductive structure, e.g., wire bonds 416-417, can be added for coils of the transformer of structure 400iv. Wire bonds 416-417 can be connected to respective conductive structure (shown as 406d-e and 406f-g, respectively) in/on substrate 401 to form primary and secondary coils of structure 400/400iv. It will be understood that for the primary and secondary transformer coils, wire bonds 416, 417 will have portions that are offset with respect to the conductive structure (shown as 406d-e and 406f-g, respectively) in/on substrate 401, in order to produce coils with multiple loops/windings about core 410. For example, for wire bond 417, first end 417a may be offset from conductive trace 406f (in the direction perpendicular to the plane of the drawing) for (lower) coil portion 407 while second end 417b may be in contact with conductive trace 406g of coil portion 407, with wire bond 417 and coil portion 407 forming a complete revolution of conductive structure (one winding) about core 410. Solder (e.g., solder balls 413) or other suitable (e.g., reflowable and/or conductive) material may be used for connections to active or passive components.

As shown for step (v), protective material 418 can be applied or provided to During operation of the transformer of structure 400, second core portion 410b can undergo size changes due to magnetostriction, free from (or substantially free from) constraint by substrate 401. Package structure 400v can be further processed, e.g., subject to a compression molding step (not shown), for forming an IC package.

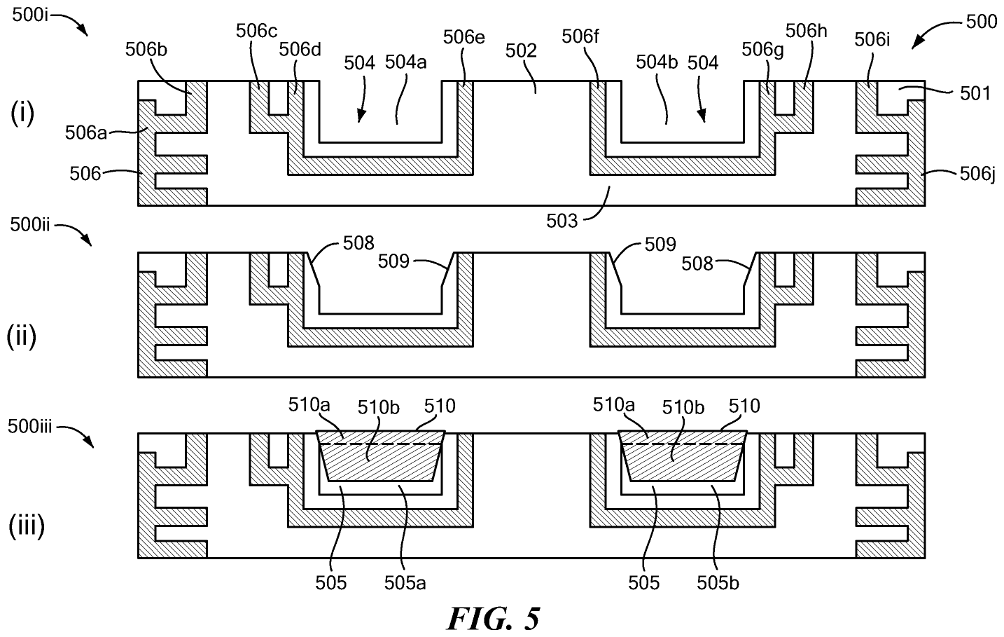

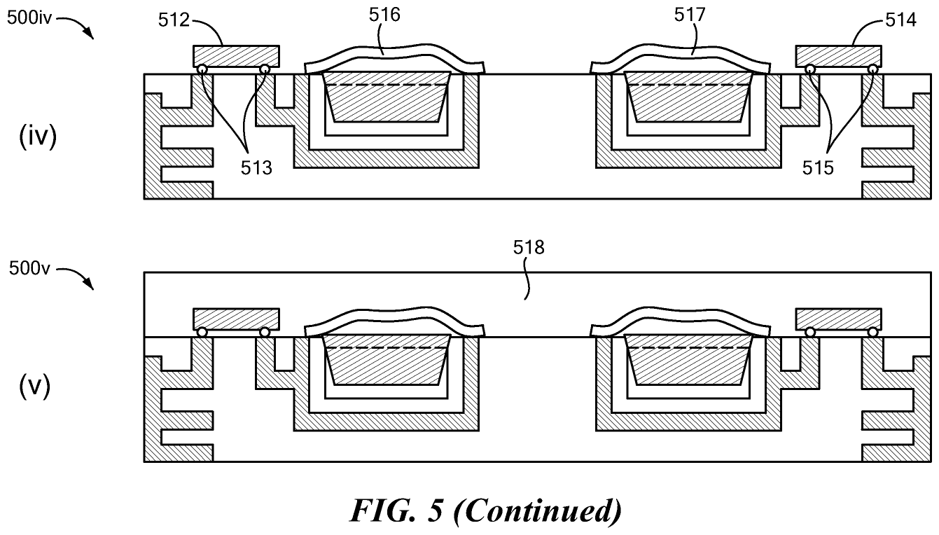

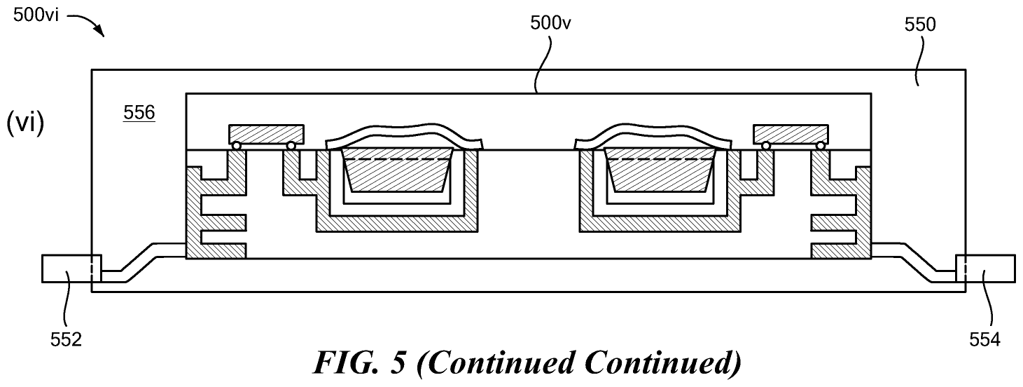

FIG. 5 is a section side view of another example wedge-type transformer-based IC package structure 500 during successive steps (i)-(vi) of fabrication, in accordance with an embodiment of the present disclosure. Transformer-based IC package structure 500 can provide voltage isolation between primary and secondary sides of the included transformer. Structure 500 includes structures 500i-500vi at different steps (i)-(vi) of fabrication, resulting in an IC package 500vi. Structure 500 is generally similar to structure 400 of FIG. 4 but includes shaped features for included core 510 and substrate 501 that facilitate positioning of the core 510 within the aperture 504 and/or sealing of the aperture 504.

As shown for step (i), structure 500i can include a substrate 501 having opposed first and second sides (surfaces) 502, 503. Substrate 501 can be formed of or include a printed circuit board (PCB) in some embodiments. An aperture 504 can be formed in substrate 501 that is configured (adapted) to receive a magnetic transformer core, shown as core 510 for steps (iii)-(vi). In some embodiments, aperture 504 can be machined or molded. Aperture 504 is shown having two cross-sections 504a-b. Aperture 504 can be shaped as a closed loop having various geometries, e.g., circular, oval, square, rectangular, polygonal, etc.

Substrate 501 can include a plurality of conductive structures (traces) 506 that can be used for connections to external components (e.g., shown as 506a and 506j), connections for internal components such as active components and/or passive components (e.g., shown as 506b, 506c, 506h, and 506i), and/or for connection to or use as transformer coils or portions of transformer coils (e.g., shown as 506d-e and 506f-g).

As shown for step (ii), the substrate 501 of structure 500ii can include angled surfaces 508, 509 at edges of aperture 504. Angled surface 508 is shown formed for surface 502 at an outer perimeter of aperture 504 while angled surface 509 is shown formed for surface 502 at an inner perimeter of aperture 504. Angled surfaces 508-509 may be formed by any suitable technique, e.g., milling or molding. Angled surfaces 508-509 can facilitate sealing between the transformer core 510 and substrate 501 and/or positioning of core 510, in some embodiments.

As shown for step (iii), structure 500iii can include a ferromagnetic core 510 including a first portion 510a and a second portion 510b. First core portion 510a can be positioned relative to (wedged into) aperture 504 to occlude or block the aperture at the first surface 502, forming a pocket or cavity 505, shown with sections 505a-b. Second core portion 510b is unconstrained by substrate 501 and may move or change size (in pocket 505) in response to magnetostriction during operation of the transformer of structure 500. For the example shown, second core 510b portion is integral with first core portion 510a. In other embodiments, the second portion 510b may be glued or adhered/affixed to first portion 510a using suitable processes/materials.

As shown for step (iv), second core portion 510b is within pocket/space 505 (indicated with sections 505a-b), formed by first core portion 510a blocking or occluding aperture 504 in surface 502 of substrate 501, and unconstrained by substrate 501. Further conductive structure, e.g., wire bonds 516-517, can be added for coils of the transformer of structure 500iv. Wire bonds 516-517 can be connected to respective conductive structure (shown as 506d-e and 506f-g, respectively) in/on substrate 501 to form primary and secondary coils of structure 500/500iv. Solder (e.g., solder balls 513) or other suitable (e.g., reflowable and/or conductive) material may be used for connections to active or passive components.

As shown for step (v), structure 500v can include protective material 518 applied (e.g., molded, potted, or dispensed) to protect components of the package. During operation of the transformer of structure 500, second core portion 510b can undergo size changes due to magnetostriction, free from (or substantially free from) constraint by substrate 501. The seal between the first substrate portion and substrate 501 can prevent protective material from entering aperture 504.

Step (vi) shows an IC package 500vi including a package body 550 encompassing structure 500v of step (v). Package body 550 can include molding material 556 encapsulating or covering structure 550v. First and second sets (pluralities) of exposed conductors (e.g., leads) 552, 554 are shown connected to conductive structures 506a and 506j, which are connected to first and second IC dies 512 and 514, respectively. Any suitable number of conductors may be included for conductor sets 552, 554, and the number of conductors may differ between the sets 552, 554. In some embodiments, conductor sets 552, 554 may extend from package body 550, e.g., as straight leads or J-leads, etc. In other embodiments, conductor sets 552, 554 may be essentially flush with (or recessed relative to) package body 550, as shown by dashed lines.

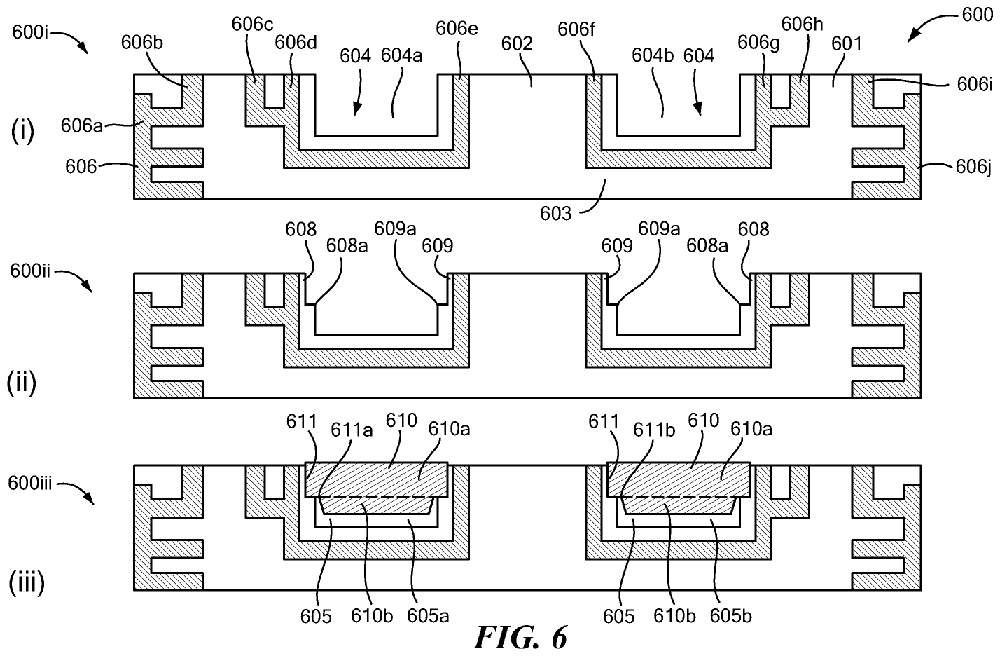

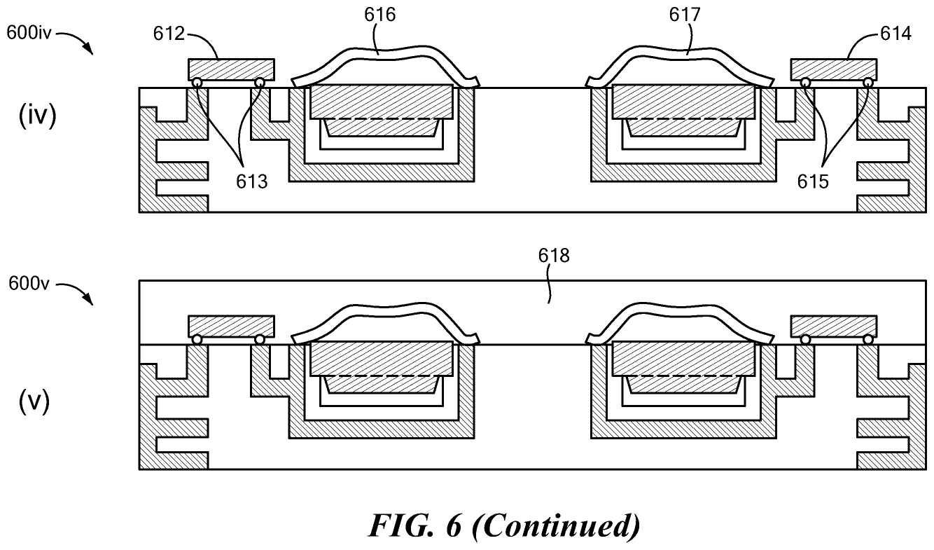

FIG. 6 is a section side view of a further example wedge-type transformer-based IC package structure during successive steps of fabrication, in accordance with an embodiment of the present disclosure. Transformer-based IC package structure 600 can provide voltage isolation between primary and secondary sides of the included transformer. Structure 600 includes structures 600i-600v at different steps (i)-(v) of fabrication. Structure 600 is generally similar to structure 500 of FIG. 5 but, for shaped features used for the included core 610 and substrate 601, includes stepped features instead of angled features.

As shown for step (i), structure 600i can include a substrate 601 having opposed first and second sides (surfaces) 602, 603. Substrate 601 can be formed of or include a printed circuit board (PCB) in some embodiments. An aperture 604 can be formed in substrate 601 that is configured to receive (adapted to) a magnetic transformer core of soft ferromagnetic material, shown as core 610 for steps (iii)-(v). In some embodiments, aperture 604 can be machined or molded. Aperture 604 is shown having two cross-sections 604a-b. Aperture 604 can be shaped as a closed loop having various geometries, e.g., circular, oval, square, rectangular, polygonal, etc.

Substrate 601 can include a plurality of conductive structures (traces) 606 that can be used for connections to external components (e.g., shown as 606a and 606j), connections for internal components such as active components and/or passive components (e.g., shown as 606b, 606c, 606h, and 606i), and/or for connection to or use as transformer coils or portions of transformer coils (e.g., shown as 606d-e and 606f-g).

As shown for step (ii), the substrate 601 of structure 600ii can include stepped surfaces 608, 609 at edges of aperture 604. Stepped surface 608 is shown formed for surface 602 at an outer perimeter of aperture 604 while stepped surface 609 is shown formed for surface 602 at an inner perimeter of aperture 604. Stepped surfaces 608-609 may be formed by any suitable technique, e.g., milling or molding. Stepped surfaces 608-609 can facilitate sealing between the transformer core 610 and substrate 601 and/or position of core 610, in some embodiments.

As shown for step (iii), structure 600iii can include a ferromagnetic core 610 including a first portion 610a and a second portion 610b. First core portion 610a can be positioned relative to aperture 604 to occlude or block the aperture 604 at the first surface 602, forming a pocket or cavity 605, shown with sections 605a-b. Second core portion 610b is unconstrained by substrate 601. For the example shown, second core portion 610b is integral with first core portion 610a. In other embodiments, the second portion 610b may be glued or adhered/affixed to first portion 610a using suitable processes/materials. As shown, second core portion 610b is within pocket/space 605 (indicated with sections 605a-b), formed by first core portion 610a blocking or occluding aperture 604 in surface 602 of substrate 601, and unconstrained by substrate 601. During operation of the transformer of structure 600, second core portion 610b can undergo size changes due to magnetostriction, free from (or substantially free from) constraint by substrate 601.

As shown for step (iv), wire bonds 616 and 617 can be provided for the primary and secondary coils of structure 600iv. As shown by IC die 612, 614, active and/or components may be added at this step. Solder (e.g., solder balls 613) or other suitable (e.g., reflowable and/or conductive) material may be used for connections to active or passive components.

As shown for step (v), structure 600v can include protective material 618 applied (e.g., molded, potted, or dispensed) to protect components of the package. Package structure 600v can be further processed, e.g., subject to a compression molding step (not shown), for forming an IC package.

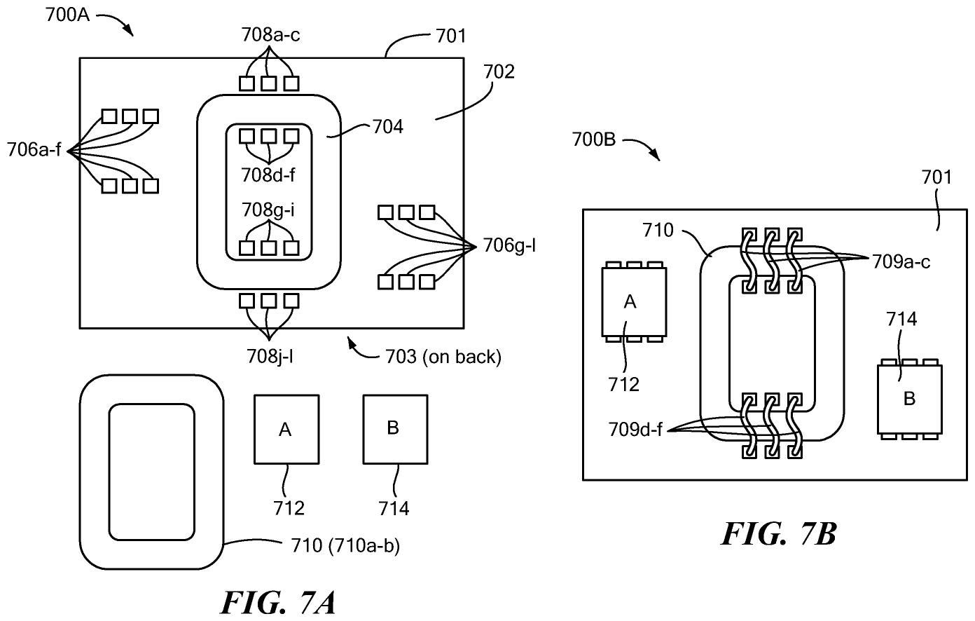

FIGS. 7A-7B show top views of an example wedge-type transformer-based IC package structure 700 in an unassembled state 700A and an assembled state 700B, respectively, in accordance with a further embodiment of the present disclosure. Transformer-based IC package structure 700 can provide voltage isolation between primary and secondary sides of the included transformer.

FIG. 7A shows structure 700A including a substrate (e.g., PCB) 701 with opposed sides 702, 703 and an aperture 704 in one side (surface) 702 of substrate 701. Aperture 704 does not pass all the way through substrate 701 (as opposed to aperture 304 for substrate 301 shown for FIG. 3A). Structure 700A includes a number of conductive pads/traces 706a-f and 706g-l configured for connection to IC die 712 and 714. Structure 700A includes a soft ferromagnetic transformer core 710 having first and second portions 710a-b. First core portion 710a is configured to block or occlude aperture 704 at surface 702 when placed (e.g., wedged) into aperture 704 (as shown in FIG. 7B).

Structure 700A can also include a number of conductive structures including pads/traces 708a-l that can be used as transformer coil portions, e.g., lower coil portions, and that can be used for connection to transformer coil portions, e.g., upper coil portions, which are shown as 709a-f in FIG. 7B for forming complete coil loops (about core 710) for the transformer in voltage-isolated package structure 700B.

FIG. 7B shows structure 700B as assembled from components in FIG. 7A. Die 712 and 714 are shown as connected to (atop) conductive pads/traces 706a-f and 706g-l. Transformer core 710 is shown with first core portion 710a covering (occluding or blocking) aperture 704. Second core portion 710b is connected (e.g., integrally) with core portion 710a and is blocked from view by first core portion 710a. Upper coil portions 709a-f are connected to conductive pads/traces 708a-l (FIG. 7A), which together with embedded/buried conductive traces in substrate 701, form complete coil loops for the primary and secondary coils of the transformer (including core 710) in transformer-based IC package structure 700B.

While not shown, in some embodiments additional active and/or passive components may be included for structure 700B. Structure 700B may be further processed, e.g., in one or more compression molding steps, to form a completed transformer-based IC package (a.k.a., transformer package). In operation of the transformer of structure 700B, second core portion 710b is unconstrained during size changes of core 710 due to magnetostriction.

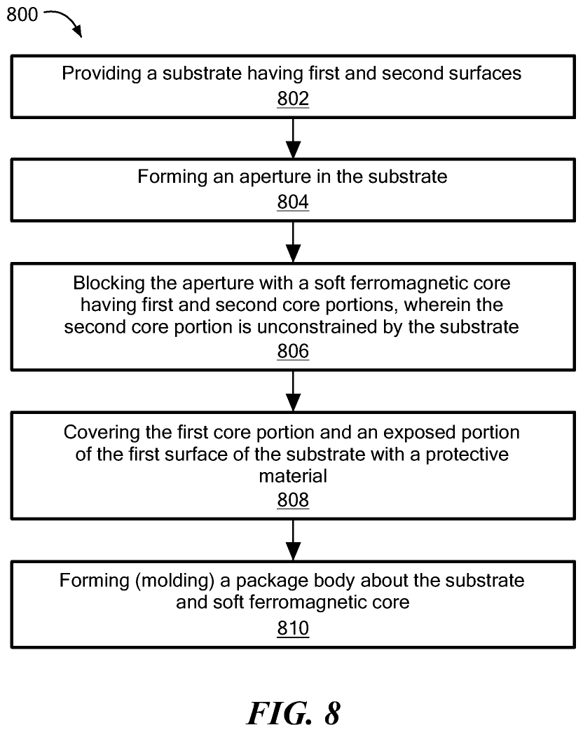

FIG. 8 is a diagram showing steps in an example method 800 of fabricating a transformer-based IC package with preformed pockets for accommodating size changes of the core due to magnetostriction, in accordance with the present disclosure. Method 800 can include providing a substrate, e.g., PCB, having first and second surfaces, as described at 802. The substrate can include conductive structure, e.g., coils or coil portions. An aperture can be provided in a surface of the substrate, as described at 804. The aperture can be blocked or covered by a portion of a ferromagnetic core having first and second core portions, with the second core portion being unconstrained by the substrate, as described at 806. One or more active and/or passive components can be connected to the substrate and/or conductive structure, e.g., first or second coils, included with or connected to the substrate. The first core portion and an exposed portion of the first surface of the substrate can be covered with a protective material, as described at 808. A package body can be formed (molded) about the substrate and ferromagnetic core, as described at 810.

Accordingly, embodiments of the inventive subject matter can afford various benefits relative to prior art techniques. For example, embodiments and examples of the present disclosure can improve the magnetic performance of isolated gate drivers, or other isolated circuits. For example, in some embodiments, for a given size transformer structure, increased current can be accommodated relative to prior art transformers. For further example, in some embodiments and applications, such improved performance can allow smaller size transformer structure (relative to prior art transformers) for a given performance level.

Various embodiments of the concepts, systems, devices, structures, and techniques sought to be protected are described above with reference to the related drawings. Alternative embodiments can be devised without departing from the scope of the concepts, systems, devices, structures, and techniques described. For example, while embodiments and examples are described herein and shown in the drawings as generally including transformer coils having an integer number of windings, turns, or loops e.g., 1, 2, etc., other examples and/or embodiments of the present disclosure may include a different number of transformer windings, turns, or loops, including a fractional number, e.g., 1.5, 2.5, 1.75, 1.8, 2.25, etc.

In some examples and/or embodiments, conductive components, e.g., integrated circuits (ICs) in die 512, 514 of FIG. 5, in a package body (e.g., body 550 of FIG. 5) can be fabricated or configured to have a desired separation distance between certain parts or features, e.g., to meet internal creepage or external clearance requirements for a given pollution degree. For example, a separation distance may be between closest voltage points or voltage regions of the respective circuits, e.g., the low (primary) side and high (secondary) side of a transformer. For further example, such a separation distance may be the distance between any two voltage points/regions between the primary and secondary sides, e.g., between die 512 and die 514 in package 500vi in FIG. 5. Such a separation distance may be or may be at least 1.2 mm, 1.4 mm, 1.5 mm, 3.0 mm, 4.0 mm, 5.5 mm, 7.2 mm, or 8.0 mm in respective examples. A distance between conductive portions of die or circuit portions can include any insulation covering a conductor, e.g., such as plastic coating of a wire/lead. In some embodiments, distances between parts of an IC package may also be designed and implemented. In some examples and embodiments, the distance between conductor portions between ICs in die, may be or may be at least 1 mm, 1.2 mm, 1.4 mm, 1.5 mm, 2 mm, 4 mm, 6 mm, 7.2 mm, 10 mm, or more (10+mm), e.g., to meet a given voltage isolation requirement, including creepage requirement(s) for a given pollution degree rating as defined by certain safety standards bodies such as the Underwriters Laboratories (UL) and/or the International Electrotechnical Commission (IEC). Distance(s) between any conductor and the exterior environment of the package (e.g., represented by the bottom and/or side in the figure) can also selected/implemented as desired for fabrication of package 550vi or other packages within the scope of the present disclosure.

In some embodiments, a dielectric material (e.g., gel) may be used for potting and/or protecting packages and/or PCB system assemblies, e.g., package 550vi of FIG. 5, to protect dies and/or interconnects from environment conditions and/or to provide dielectric insulation. In some examples, a dielectric material may include, but is not limited to, one or more of the following materials: DOWSIL™ EG-3810 Dielectric Gel (made available by The Dow Chemical Corporation, a.k.a., “Dow”, and DOWSIL™ EG-3896 Dielectric Gel (made available by Dow), which has the ability to provide isolation greater than 20 kV/mm. Other suitable gel materials may also or instead be used, e.g., to meet or facilitate meeting/achieving voltage isolation specifications required by a given package design. DOWSIL™ EG-3810 is designed for temperature ranges from −60° C. to 200° C. and DOWSIL™ EG-3896 Dielectric Gel −40° C. to +185° C.; both of which can be used to meet typical temperature ranges for automotive applications.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration.” Any embodiment or design described as “exemplary” is not necessarily to be construed as preferred or advantageous over other embodiments or designs. The terms “one or more” and “at least one” indicate, unless expressly stated otherwise herein, any integer number greater than or equal to one, e.g., one, two, three, four, etc.; in some embodiments, where context admits, the terms “one or more” and “at least one” can indicate a fractional value. The term “plurality” indicates any integer number greater than one. The term “connection” can include an indirect “connection” and a direct “connection.”

References in the specification to “embodiments,” “one embodiment,” “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within +5% of one another in some embodiments, and yet within ±2% of one another in some embodiments.

The term “substantially” may be used to refer to values that are within ±20% of a comparative measure in some embodiments, within +10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the description provided herein or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A method of making a transformer package with controlled magnetostriction, the method comprising:
providing a substrate having first and second surfaces;
forming an aperture in the substrate;
blocking the aperture with a ferromagnetic core including soft ferromagnetic material and having first and second core portions, wherein the second core portion is unconstrained by the substrate;
covering the first core portion and an exposed portion of the first surface of the substrate with a protective material; and
forming a body about the substrate and ferromagnetic core, wherein the body comprises a mold material.

2. The method of claim 1, wherein the aperture comprises first and second apertures in the first surface of the substrate connected by a cavity in the second surface of the substrate.

3. The method of claim 2, further comprising bonding the second core portion to the first core portion.

4. The method of claim 1, wherein the aperture comprises a cavity with a closed shape and surrounding a region of the first surface of the substrate, wherein the first core portion has a shape matching the closed shape of the cavity.

5. The method of claim 1, wherein blocking the aperture with the first core portion comprises covering the aperture with the first core portion, wherein the first core portion has an area greater than that of the aperture.

6. The method of claim 1, further comprising providing the first core portion with a shaped surface configured for reception by a receiving surface of the substrate.

7. The method of claim 6, wherein the shaped surface comprises one or more surfaces oblique to the substrate.

8. The method of claim 6, wherein the shaped surface comprises one or more stepped surfaces.

9. The method of claim 1, wherein the substrate comprises a printed circuit board (PCB).

10. The method of claim 1, wherein the substrate comprises a lead frame.

11. The method of claim 1, wherein the substrate comprises a ceramic substrate.

12. The method of claim 1, wherein the substrate comprises an alumina substrate.

13. The method of claim 1, wherein the substrate comprises a glass substrate.

14. The method of claim 1, wherein the aperture includes an elliptical shape.

15. The method of claim 1, wherein the aperture includes a circular shape.

16. The method of claim 1, wherein the aperture includes a rectangular shape.

17. The method of claim 1, wherein the aperture includes a square-like shape.

18. The method of claim 1, further comprising applying an adhesive between the first surface of the substrate and the first core portion for facilitating sealing of the aperture.

19. The method of claim 18, wherein the adhesive comprises epoxy loaded with soft ferromagnetic material.

20. The method of claim 1, further comprising covering the second core portion and the second surface of the substrate with a protective material.

21. The method of claim 1, further comprising mounting one or more circuit components to the first surface of the substrate.

22. The method of claim 21, wherein the one or more circuit components comprise one or more integrated circuit die.

23. The method of claim 1, wherein the substrate includes a plurality of first coil portions configured to extend about the ferromagnetic core, and further comprising connecting a plurality of second coil portions to the plurality of first coil portions, forming a plurality of coil windings about the ferromagnetic core.

24. The method of claim 23, wherein the plurality of coil windings comprise primary and secondary transformer coils configured for magnetic coupling.

25. The method of claim 1, wherein the substrate comprises first and second transformer coils disposed about the aperture and configured for magnetic coupling.

26. The method of claim 1, wherein the ferromagnetic core comprises ferrite.

27. A transformer package having controlled magnetostriction, the transformer package comprising:
a substrate with first and second surfaces, wherein an aperture is disposed in the first surface;
a ferromagnetic core including soft ferromagnetic material and having first and second core portions, wherein the first core portion is configured to block the aperture, and wherein the second core portion is unconstrained by the substrate; and
a body disposed about the substrate and ferromagnetic core, wherein the body comprises a mold compound.

28. The transformer package of claim 27, wherein the aperture comprises first and second apertures in the first surface of the substrate connected by a cavity in the second surface of the substrate.

29. The transformer package of claim 28, wherein the second core portion is affixed to the first core portion.

30. The transformer package of claim 29, further comprising an adhesive disposed between the first core portion and the second core portion.

31. The transformer package of claim 30, wherein the adhesive comprises epoxy loaded with soft ferromagnetic material.

32. The transformer package of claim 27, wherein the second core portion is integral with the first core portion.

33. The transformer package of claim 27, wherein the aperture comprises a cavity with a closed shape and surrounding a region of the first surface of the substrate, wherein the first core portion has a shape matching the closed shape of the cavity.

34. The transformer package of claim 27, wherein the first core portion has an area greater than that of the aperture.

35. The transformer package of claim 27, wherein the first core portion includes a shaped surface configured for reception by a receiving surface of the substrate.

36. The transformer package of claim 35, wherein the shaped surface comprises one or more surfaces oblique to the substrate.

37. The transformer package of claim 35, wherein the shaped surface comprises one or more stepped surfaces.

38. The transformer package of claim 27, wherein the substrate comprises a printed circuit board (PCB).

39. The transformer package of claim 27, wherein the substrate comprises a lead frame.

40. The transformer package of claim 27, wherein the substrate comprises a ceramic substrate.

41. The transformer package of claim 27, wherein the substrate comprises an alumina substrate.

42. The transformer package of claim 27, wherein the substrate comprises a glass substrate.

43. The transformer package of claim 27, wherein the aperture includes an elliptical shape.

44. The transformer package of claim 27, wherein the aperture includes a circular shape.

45. The transformer package of claim 27, wherein the aperture includes a rectangular shape.

46. The transformer package of claim 27, wherein the aperture includes a square-like shape.

47. The transformer package of claim 27, further comprising an adhesive disposed between the first surface of the substrate and the first core portion for facilitating sealing of the aperture.

48. The transformer package of claim 27, further comprising a protective material covering the first core portion and an exposed portion of the first surface of the substrate.

49. The transformer package of claim 27, further comprising a protective material covering the second core portion and the second surface of the substrate.

50. The transformer package of claim 27, further comprising one or more circuit components disposed on the first surface of the substrate.

51. The transformer package of claim 50, wherein the one or more circuit components comprise one or more integrated circuit die.

52. The transformer package of claim 27, further comprising:
a plurality of first coil portions disposed in the substrate and extending about the ferromagnetic core; and
a plurality of second coil portions connected to the plurality of first coil portions, wherein the plurality of second coil portions extend about the ferromagnetic core, and wherein the plurality of first coil portions and plurality of second coil portions, as connected, form a plurality of continuous coil loops about the ferromagnetic core.

53. The transformer package of claim 52, wherein the plurality of continuous coil loops comprise primary and secondary transformer coils configured for magnetic coupling.

54. The transformer package of claim 52, wherein the plurality of second coil portions comprise wire bonds.

55. The transformer package of claim 27, wherein the substrate comprises first and second transformer coils disposed about the aperture and configured for magnetic coupling.

56. The transformer package of claim 27, wherein the ferromagnetic core comprises ferrite.
